(19) United States
(12) Patent Application Publication
(10) Pub. No.: US 2009/0109911 A1
(43) Pub. Date: Apr. 30, 2009

(54) OBTAINING CHANNEL FEEDBACK FROM USERS IN A WIRELESS COMMUNICATION SYSTEM

(75) Inventors: Marios Nicolaou, Strovolos (CY); Angela Doufexi, Bristol (GB); Simon Armour, Bath (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The University of Bristol, Bristol (GB)

(21) Appl. No.: 12/256,455

(22) Filed: Oct. 22, 2008

(30) Foreign Application Priority Data
Oct. 26, 2007 (GB) 0721027.1

(51) Int. Cl. H04W 24/00

(52) U.S. Cl. 370/329

(57) ABSTRACT

Subchannel feedback is provided from a plurality of mobile devices to a base station in a communication system, in which a channel is divided into available subchannels. The base station first requests channel information from the mobile devices, and then receives the channel information, for example in the form of an average Effective Signal to Noise Ratio for the channel. Based on the received channel information, the base station selects a subset of the mobile devices, i.e. the best mobile devices. The base station then requests subchannel information relating to a subset of the available subchannels, from the selected subset of the mobile devices, and receives the subchannel information in the form of information identifying said subset of the available subchannels, without indicting a quality of said subset of the available subchannels.

### CROSS-REFERENCES TO RELATED APPLICATIONS

This application claims priority from United Kingdom application number 0721027.1, filed Oct. 26, 2007, which is incorporated by reference.

### BACKGROUND

This invention relates to a wireless communication system, and in particular to a wireless communication system in which a base station serving multiple users over respective wireless links obtains feedback from those users relating to the respective channel conditions.

Wireless communication systems are known, in which a base station serves multiple users, each of which requires a respective wireless link for data communication with the base station. In systems using Orthogonal Frequency Division Multiple Access (OFDMA), the bandwidth available for uplink transmission from the users to the base station is divided into multiple subcarriers. These subcarriers can then be allocated to different users, in order to allow those users to transmit signals to the basestation.

In order to account for varying transmission requirements of the users, different users can be allocated different numbers of subcarriers from one time period to the next.

It is known to perform opportunistic scheduling, that is, to allocate subcarriers to users taking account of the spectral variations of the channel, by scheduling users only on subcarriers where they will have good channel conditions. In addition, account can be taken of the inherent variations of the channel conditions with time. If each subcarrier could be allocated to the user with the best channel conditions at any instant, the overall data throughput could be maximized.

In order for the base station to be able to allocate subcarriers to users taking account of these factors, it is necessary for the users to provide feedback information to the base station, relating to the instantaneous channel conditions. In order to be able to determine the absolutely optimal allocation of subcarriers to users, the base station would require feedback from every user in every time period, regarding every frequency subcarrier. However, this requirement would mean that significant resources would need to be allocated specifically for the users to provide the necessary feedback, and so the useful data throughput would be compromised.

Various schemes therefore exist for providing channel feedback from users to a base station, in order to reduce the feedback requirement, while still allowing throughput gains to be achieved.

For example, Svedman, et al, “A Simplified Opportunistic Feedback and Scheduling Scheme for OFDM” IEEE VTC 2004-Spring, pages 1878-1882 describes grouping adjacent subcarriers into clusters, on the assumption that all of the subcarriers in one such cluster will typically have a similar channel response. In addition, each user then feeds back information only about clusters that are instantaneously strong. This reduces the feedback overhead, while ensuring that the base station still receives information that is useful for scheduling. Specifically, each user feeds back the cluster indices and the average signal-to-noise ratios (SNRs) of a certain number of strongest clusters. For each cluster, the base station chooses among all the users that fed back that cluster index, and allocates the cluster to the user that reported the highest SNR.

Further, T.-S. Kang and H.-M. Kim, “Opportunistic Feedback Assisted Scheduling and Resource Allocation in OFDMA Systems,” 10th IEEE Singapore International Conference on Communication Systems, ICCS 2006 describes a system in which a base station receives information from users, relating to their average SNR over an available channel. Based on the received SNR information, the base station selects the “best” users, and requests subband information from these users. These selected users then determine their “best” subbands, and feed back the channel state information relating to these subbands. The base station then assigns the subbands to the selected users.

### SUMMARY

Although the Svedman et al and Kang et al documents discussed above describe systems in which the feedback overhead is reduced, compared with a system in which each user feeds back SNRs for each individual subcarrier, this overhead remains considerable.

This is particularly relevant in a system in which the users may be moving at relatively high speeds, and the channels between the base station and the users may therefore have relatively large delay spreads, in which case the uplink feedback overhead can significantly impact on the overall performance of the wireless link.

According to the present invention, there is provided a method of obtaining subchannel feedback from a plurality of mobile devices in a communication system, in which a channel is divided into a plurality of available subchannels, the method comprising:

requesting channel information from the plurality of mobile devices;

receiving channel information from the plurality of mobile devices;

based on the received channel information, selecting a subset of the mobile devices;

requesting subchannel information relating to a subset of the available subchannels, from the selected subset of the mobile devices; and

receiving said subchannel information in the form of information identifying said subset of the available subchannels, without indicating a quality of said subset of the available subchannels.

According to a further aspect of the invention, there is provided a method of providing subchannel feedback, for use in a mobile device in a communication system, in which a channel is divided into a plurality of available subchannels, the method comprising:

receiving a request for subchannel information;

identifying a preferred subset of the available subchannels; and

transmitting to a base station indices identifying the preferred subset of the available subchannels, without also transmitting subchannel quality information relating to the preferred subset of the available subchannels.

According to still further aspects of the invention, there are provided a base station and a mobile device, for use in the communication system.

As used herein, the term “base station” refers to any device in the communication network that performs resource allocation, which may or may not be performing the other functions associated with a base station in a conventional cellular network.

These have the advantage that a high downlink spectral efficiency can be achieved, without requiring a large uplink feedback overhead.

### BRIEF DESCRIPTION OF THE DRAWINGS

FIG. 1 is a schematic illustration of a mobile communication system in accordance with an aspect of the invention; and

FIG. 2 is a flow chart, illustrating a method in accordance with an aspect of the present invention.

### DESCRIPTION OF EXEMPLARY EMBODIMENTS

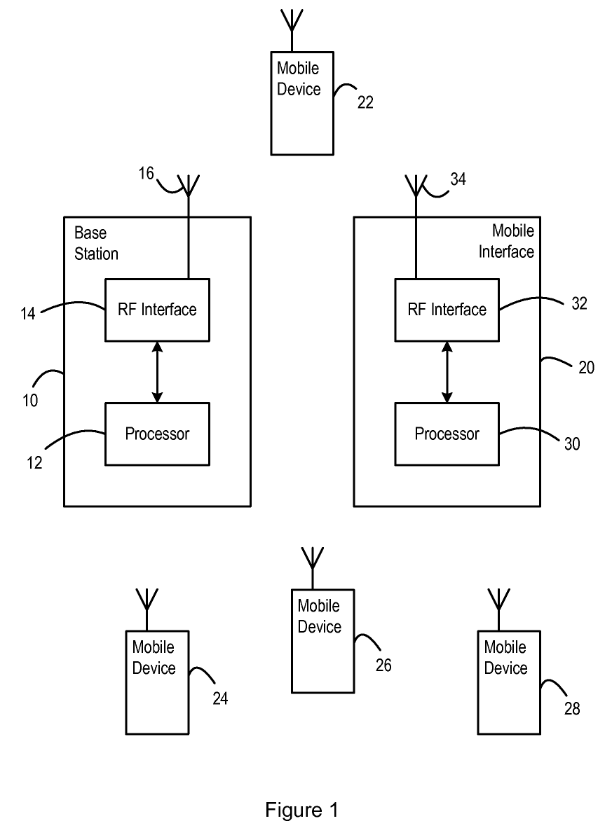

FIG. 1 shows a wireless communication system, having a base station 10. As is generally conventional, the base station 10 operates under the control of a processor 12, and sends and receives wireless communication signals by means of a radio frequency (RF) interface 14 and an antenna 16. In some embodiments of the invention, the base station 10 may have a connection into a wider communication network such as the internet, in order to allow data to be transmitted and received over that network. The base station 10 may also, or alternatively, have a connection into a core network of a mobile communication network, and in that case data may be transmitted and received over that network, and some or all of the operation of the base station 10 may in that case be generally controlled by further network nodes in the mobile communication network.

FIG. 1 also shows multiple mobile devices 20, 22, 24, 26, 28, located within a coverage area of the base station 10. The form of these mobile devices is generally known, and they are generally similar, and so only one mobile device 20 is described in further detail. Specifically, the mobile device 20 operates under the control of a processor 30, and sends and receives wireless communication signals by means of a radio frequency (RF) interface 32 and an antenna 34. The mobile devices may for example be telephone handsets, laptop or portable computers, PDAs, or the like. Although these user devices are referred to as mobile devices herein, it will be appreciated that they may be fixed or semi-static in location, provided that they are able to establish a wireless connection with the base station 10 over a suitable wireless communication protocol.

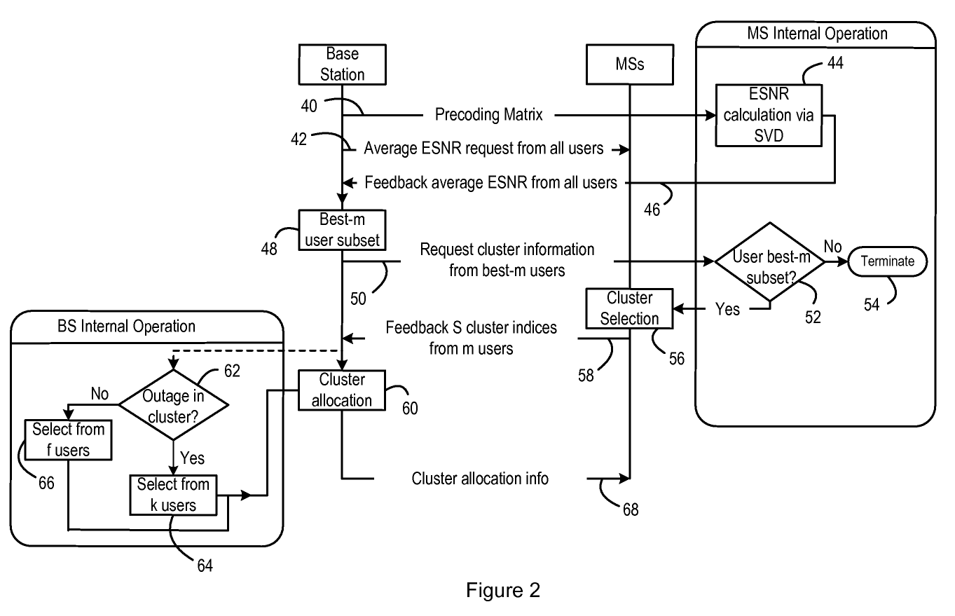

FIG. 2 shows a process in accordance with the present invention, having steps performed in the base station 10 and in the mobile device 20.

Thus, the invention is described with reference to a centralized network, in which mobile devices communicate with a base station, and processes relating to resource allocation are performed in the base station. However, the invention is equally applicable to other decentralized, or ad hoc, networks, in which one mobile device can act as the base station, in obtaining subchannel feedback and allocating resources, for itself and/or for other mobile devices.

In step 40, the base station 10 broadcasts a precoding matrix that can be detected by all mobile stations. The form of this signal will be determined by the system configuration. For example, in a Multiple Input Single Output (MISO) system, where the base station antenna 16 contains multiple antennas, and each mobile device antenna 34 contains a single antenna, a data vector may be transmitted. In a Multiple Input Multiple Output (MIMO) system, where the base station antenna 16 contains multiple antennas, and each mobile device antenna 34 also contains multiple antennas, a precoding matrix may be transmitted. One suitable form of a precoding matrix is known, for example, from Chung, et al, “A Random Beamforming Technique in MIMO Systems Exploiting Multi-user Diversity”, IEEE Journal on Selected Areas in Communications, Vol. 21, No. 5.

In step 42, the base station 10 requests an average Effective Signal to Noise Ratio (ESNR) value from each user. In step 44, each user determines the average ESNR by a technique using singular value decomposition (SVD) of the precoding matrix. Han, et al, “Random Beamforming OFDMA for Future Generation Cellular Communication Systems”, IEEE-VTC2007-Fall, pages 516-520 describes the SVD technique for calculating the ESNR value.

Assuming that it is calculated across all available subchannels, this average ESNR value calculated by a mobile station provides an indication of the relative distance and of the overall channel quality between the base station and that mobile station, because each mobile station is calculating the ESNR value from the same transmitted precoding matrix.

In step 46, each mobile station feeds back its respective calculated average ESNR value to the base station 10.

In step 48, the base station 10 selects the best m users from the mobile stations that request service by feeding back average ESNR values.

Specifically, the base station 10 selects the best m users according to the equation:

Uₘ(t)={k|f₍₁₎(t),f₍₂₎(t), . . . , f₍ₘ₎(t)}.

Thus, this equation provides a list of the best m users, sorted in descending order. The criterion for determining the best users can be set by choosing a function f₍ₙ₎(t)=rₖ(t), rₖ(t) being the average data rate of user k for an OFDM symbol, i.e. the average data rate that would hypothetically be achieved by assigning all available subchannels with total bandwidth W to the user k, this being derivable from Shannon's equation rₖ=W log₂(1+ESNR). Since this determines the best users simply by means of their signal strengths, this can be termed maximum ESNR scheduling.

Other methods of selecting the best m users are possible. As one alternative, it is possible to select the best users by a method that can be termed Proportionally Fair scheduling, where account is also taken of the resources that have previously been allocated to a user. In that case, a function f₍ₙ₎(t)=rₖ(t)| R̅ₖ̅(t−1) can be used, where R̅ₖ̅(t−1) is the average data rate that the user k has been able to achieve from the resources actually allocated to it, measured over an exponentially weighted window length T_{c}.

Thus, the base station 10 receives the ESNR values from each user, and then selects the “best” users by determining which of the users will be able to achieve the highest data rate if allocated resources. If the Proportionally Fair scheduling method is used, this also takes into account each user's previously achieved data rate. Thus, even if a user is relatively far from the base station, and thus detects the precoding matrix with a relatively poor ESNR, it will still be allocated sufficient resources.

As mentioned above, the base station 10 selects the best m users from all of the users that return ESNR values. The value of the number m is determined in conjunction with other parameter values, as will be discussed in more detail below.

In step 50 of the process shown in FIG. 2, the base station 10 requests subchannel information from the selected best m users. That is, the base station requests information that will allow it to allocate subchannels to users. In this illustrated embodiment of the invention, the available subchannels are grouped into clusters, and the base station 10 requests cluster information from the selected best-m users.

For example, in an embodiment of the invention where there are a total number N of subchannels available for data transmission, these may be divided into D clusters, each containing R subchannels, with D=N/R. For example, where there are 1024 subchannels available for data transmission, these may be divided into 32 clusters, each containing 32 subchannels. Feeding back information about the channel conditions relating to a number of clusters clearly requires less data than feeding back information about the same total number of subchannels individually, but is only suitable if all of the subchannels in one cluster are sufficiently well correlated with each other. The cluster size will generally be fixed by the base station 10, but may be varied if channel conditions change.

In step 50, the base station 10 may request the cluster information by broadcasting a message identifying the selected best m users, or by sending a message to each user, informing it whether it is one of the selected best m users.

In step 52, each user detects the message sent by the base station 10 in step 50, and determines whether it is one of the selected best m users. If it determines that it is not, the process passes to step 54, where it terminates for that user. If the user determines in step 52 that it is one of the selected users, the process passes to step 56, in which the mobile device selects the subchannels, or clusters in the illustrated embodiment, on which it will report.

In this illustrated embodiment of the invention, the base station 10 does not request from the best m users subchannel ESNR relating to all of the available subchannels. Rather, the base station 10 requests information relating to a selected subset comprising S of the clusters. More specifically, the base station 10 requests that each mobile device identify, and feed back the identities of, their S strongest clusters. The value of the number S is determined in conjunction with other parameter values, as will be discussed in more detail below.

Thus, in step 56, each mobile device identifies its strongest S clusters, out of the total number D of clusters. Thus, the mobile device determines the ESNR in each separate cluster, and then lists the S clusters, for which this ESNR value is the highest, according to the equation:

Cₖ(t)={n|c_{k,(1)}(t),c_{k,(2)}(t), . . . , c_{k(S)}(t)}

where:

c_{k,n}(t)=log₂(D_{S}),D_{S}εD

Thus, having selected its S strongest clusters in step 56, in step 58 the mobile device feeds back the indices D_{S} of these clusters. Thus, in this illustrated embodiment of the invention, the mobile device is not required to feed back any additional information. For example, it is not required to feed back any information indicating the relative or absolute strengths of the clusters within the S strongest clusters.

In step 60, the base station 10 allocates the subbands to the mobile stations. In this embodiment of the invention, in which the subcarriers have been grouped into clusters, it is the clusters that are allocated to the users. That is, within each time period, all of the subcarriers in one cluster are allocated to a single user.

In more detail, it is determined in step 62 whether a subband has been identified by one or more of the m best users as being within its S strongest clusters. If not, this is termed an “outage” with regard to that cluster, and the process passes to step 64. In step 64, that cluster is allocated to one of the users. For example, that cluster may be allocated at random to any one of the K active mobile devices in the system. In other examples, a cluster that is in outage may be allocated to any of the mobile devices identified as the m best, or may be allocated on the basis of some non-random criterion.

If it is determined in step 62 that a cluster has been identified by a number f comprising one or more, of the m best users as being within its S strongest clusters, then, in step 66, that cluster is allocated to one of those f users. Where f is more than one, the cluster may be allocated at random to one of those f users. While there may be some non-random mechanism for allocating clusters in this situation, the base station has no detailed information about the respective channel conditions, and so is unable to use this as a criterion for allocation.

This process is performed for each cluster in turn.

Then, in step 68, the base station 10 transmits a message containing the subband allocation information. Each mobile device can then detect this transmission, and can schedule its transmissions on any allocated subband or subbands.

As mentioned above, there is a relationship between the various parameters discussed previously, and the choice of values for these parameters affects the efficiency of the resource allocation.

The cluster size, R subchannels, and hence the number D of clusters, may be chosen on the basis of the channel conditions. In practice, the requirement for all of the channels in a cluster to be sufficiently well correlated imposes a maximum cluster size, and hence a minimum number of clusters.

The chosen values for the number m of users from which feedback is requested, and for the number S of clusters about which feedback is requested, will determine the total feedback requirement imposed on the mobile devices, and will determine the amount of data on which the base station 10 can base its cluster allocation decisions. In an embodiment of the invention, the processor 12 of the base station 10 can access a look-up table, containing preferred values of these parameters for different total numbers of users and different numbers of clusters. When performing the selection in step 48 above, and when transmitting the request for feed back information in step 50 described above, the base station 10 can then access the look-up table to obtain the desired parameter values.

It has surprisingly been found that a high degree of overall spectral efficiency can be achieved if the values for the number m of users from which feedback is requested, and the number S of clusters about which feedback is requested, are chosen so that a significant number of clusters are in outage, that is a significant number of the clusters are not identified by any of the m best users as being within their S strongest clusters. For example, this significant number may be in the region of 10%-20%, and more specifically may be approximately 15%.

If lower values of m and/or S are chosen, so that this percentage is higher, the random allocation of clusters in outage means that too many of the clusters are being allocated in this random way, to users that may not be able to use them efficiently. If higher values of m and/or S are chosen, so that this percentage is lower, the efficiency is compromised by the higher feedback requirement, and moreover the base station is unable to identify the very strong clusters that a mobile device would be able to use particularly efficiently, because each cluster is likely to be identified by a larger number of users.

This implies that, as the number of active users increases, the value of m should be kept substantially constant, or, alternatively, if the value of m is increased, the selected value of S should become lower, in order to maximize the spectral efficiency. The person skilled in the art can select suitable values for these parameters from the information given herein, and additionally based on the details of the system to which the invention is to be applied, such as the number of available subcarriers, the cluster size, the overall channel quality, and the number of active users.

While this method does not achieve such a high degree of downlink spectral efficiency as a system in which the base station knows the Effective Signal to Noise Ratio for each user in respect of each downlink cluster, it achieves this degree of downlink spectral efficiency at a much lower cost, in terms of the feedback overhead.

There is therefore described a method of obtaining feedback information, which allows efficient allocation of subchannels to users, without requiring the transmission of large amounts of feedback information.

What is claimed is:

1. A method of obtaining subchannel feedback from a plurality of mobile devices in a communication system, in which a channel is divided into a plurality of available subchannels, the method comprising:
requesting channel information from the plurality of mobile devices;
receiving channel information from the plurality of mobile devices;
based on the received channel information, selecting a subset of the mobile devices;
requesting subchannel information relating to a subset of the available subchannels, from the selected subset of the mobile devices; and
receiving said subchannel information in the form of information identifying said subset of the available subchannels, without indicating a quality of said subset of the available subchannels.

2. A method as claimed in claim 1, wherein the step of requesting channel information comprises transmitting a precoding matrix.

3. A method as claimed in claim 1, wherein the step of receiving channel information comprises receiving an average Effective Signal to Noise Ratio for the channel.

4. A method as claimed in claim 1, wherein the step of requesting subchannel information comprises requesting information relating to at least one cluster comprising a plurality of subchannels.

5. A method as claimed in claim 4, wherein the step of requesting subchannel information comprises determining a number of clusters, and requesting information relating to said determined number of clusters.

6. A method as claimed in claim 1, wherein the step of selecting the subset of the mobile devices comprises selecting a plurality of said mobile devices, the selected plurality of mobile devices being mobile devices that report the best channels.

7. A method as claimed in claim 1, wherein the step of requesting subchannel information comprises requesting information relating to a number of clusters, and further comprising, for each cluster, allocating all subchannels in the cluster to a single user, based on the received subchannel information.

8. A method as claimed in claim 1, wherein the step of requesting subchannel information comprises requesting that each mobile device in the selected subset of mobile devices identify a predetermined number of strongest clusters of subchannels.

9. A method as claimed in claim 8, further comprising:
for each cluster, determining whether the cluster was identified by any mobile device in the selected subset of mobile devices as one of its strongest clusters; and
if so, allocating that cluster to a mobile device that identified the cluster as one of its strongest clusters.

10. A method as claimed in claim 9, further comprising:
if a cluster was not identified by any mobile device in the selected subset of mobile devices as one of its strongest clusters, allocating that cluster at random to a mobile device.

11. A method as claimed in claim 9, further comprising:
if a cluster was identified by more than one mobile device in the selected subset of mobile devices as one of its strongest clusters, allocating that cluster at random to one of said mobile devices that identified the cluster as one of its strongest clusters.

12. A method as claimed in claim 8, wherein the predetermined number of strongest clusters of subchannels is chosen such that approximately 85% of all clusters are identified by one or more mobile devices as one of their predetermined number of strongest clusters.

13. A base station, for use in a communication system, in which a channel is divided into a plurality of available subchannels, the base station being adapted to obtain subchannel feedback from a plurality of mobile devices by:
requesting channel information from the plurality of mobile devices;
receiving channel information from the plurality of mobile devices;
based on the received channel information, selecting a subset of the mobile devices;
requesting subchannel information relating to a subset of the available subchannels, from the selected subset of the mobile devices; and
receiving said subchannel information in the form of information identifying said subset of the available subchannels, without indicating a quality of said subset of the available subchannels.

14. A base station as claimed in claim 13, further adapted to allocate subchannels to mobile devices by:
requesting that each mobile device in the selected subset of mobile devices identify a predetermined number of strongest clusters of subchannels; and
for each cluster, determining whether the cluster was identified by any mobile device in the selected subset of mobile devices as one of its strongest clusters; and
if the cluster was identified by one mobile device in the selected subset of mobile devices as one of its strongest clusters so, allocating that cluster to said one mobile device;
if the cluster was identified by a plurality of mobile devices in the selected subset of mobile devices as one of their strongest clusters, allocating that cluster at random to one of said plurality of mobile devices.

15. A method of providing subchannel feedback, for use in a mobile device in a communication system, in which a channel is divided into a plurality of available subchannels, the method comprising:
receiving a request for subchannel information;
identifying a preferred subset of the available subchannels; and
transmitting to a base station indices identifying the preferred subset of the available subchannels, without also transmitting subchannel quality information relating to the preferred subset of the available subchannels.

16. A method as claimed in claim 15, wherein the received request for subchannel information includes a number of subchannels to be included in the preferred subset of the available subchannels.

17. A method as claimed in claim 15, comprising:
receiving a first signal from the base station;
determining from the received first signal an average Effective Signal to Noise Ratio for the channel;
transmitting a feedback signal indicative of the determined average Effective Signal to Noise Ratio for the channel;
receiving a second signal from the base station; and
determining whether the received second signal is said request for subchannel information.

18. A wireless communications device, for use in a in a communication system in which a channel is divided into a plurality of available subchannels, the wireless communications device being adapted to provide subchannel feedback to a base station by:
receiving a request for subchannel information;
identifying a preferred subset of the available subchannels; and
transmitting to the base station indices identifying the preferred subset of the available subchannels, without also transmitting subchannel quality information relating to the preferred subset of the available subchannels.

19. A wireless communications device as claimed in claim 18, wherein the received request for subchannel information includes a number of subchannels to be included in the preferred subset of the available subchannels.

20. A wireless communications device as claimed in claim 18, further adapted to:
receive a first signal from the base station;
determine from the received first signal an average Effective Signal to Noise Ratio for the channel;
transmit a feedback signal indicative of the determined average Effective Signal to Noise Ratio for the channel;
receive a second signal from the base station; and
determine whether the received second signal is said request for subchannel information.
